(19) United States
(12) Patent Application Publication
(10) Pub. No.: US 2025/0306414 A1
(43) Pub. Date: Oct. 2, 2025

(54) DISPLAY PANEL AND DISPLAY DEVICE

(71) Applicant: AUO Corporation, Hsinchu City (TW)

(72) Inventors: Wang-Shuo Kao, Hsinchu City (TW); Shang-Wei Hsieh, Hsinchu City (TW); Jia-Hong Wang, Hsinchu City (TW); Yi-Wen Lin, Hsinchu City (TW); Chien-Yi Lin, Hsinchu City (TW); Pei-Wan Hsiao, Hsinchu City (TW); Ya-Ling Hsu, Hsinchu City (TW); Chen-Hsien Liao, Hsinchu City (TW)

(73) Assignee: AUO Corporation, Hsinchu City (TW)

(21) Appl. No.: 18/974,800

(22) Filed: Dec. 10, 2024

(30) Foreign Application Priority Data
Mar. 29, 2024 (TW) 113111899

(51) Int. Cl. G02F 1/1333; G02F 1/13357; G02F 1/1341

(52) U.S. Cl. CPC G02F 1/133357; G02F 1/133603; G02F 1/133606; G02F 1/1341

(57) ABSTRACT

A display panel having a liquid crystal display region and a side display region is provided. The display panel includes a lower substrate, a planarization layer, and a plurality of light emitting diodes (LEDs). The planarization layer is disposed on the lower substrate and extends from the liquid crystal display region to the side display region. The planarization layer defines a plurality of notches in the side display region. The LEDs are respectively disposed in the notches. A reflectance of an inner surface of each of the notches is greater than 50%. A display device is also provided.

### CROSS-REFERENCE TO RELATED APPLICATION

This application claims the priority benefit of Taiwan application serial no. 113111899, filed on Mar. 29, 2024. The entirety of the above-mentioned patent application is hereby incorporated by reference herein and made a part of this specification.

### BACKGROUND

### Technical Field

The disclosure relates to a display panel and a display device.

### Description of Related Art

A conventional liquid crystal display panel includes a plurality of liquid crystal pixels arranged within a display region for display, while sides of the liquid crystal display panel remain inactive and do not contribute to the visual output. When multiple conventional liquid crystal display panels are spliced together to create a spliced display device, edges of each display panel create visible splicing seams, reducing the display quality of the spliced display device.

### SUMMARY

The disclosure provides a display panel and a display device, where the display device is formed by splicing multiple display panels, and there are no splicing seams between the display panels.

According to an embodiment of the disclosure, a display panel having a liquid crystal display region and a side display region is provided. The display panel includes a lower substrate, a planarization layer, and a plurality of light emitting diodes (LEDs). The planarization layer is disposed on the lower substrate and extends from the liquid crystal display region to the side display region of the display panel. The planarization layer defines a plurality of notches in the side display region. The LEDs are respectively disposed in the notches in the side display region, where a reflectance of an inner surface of each of the notches is greater than 50%.

According to an embodiment of the disclosure, a display device including the display panels disposed in an array is provided, where at least two of the side display regions are adjacent to each other.

In light of the foregoing, the display panel provided in one or more embodiments of the disclosure may display images in its liquid crystal display region and may also display images in its side display region through the LEDs. Therefore, when forming a display device by splicing the display panels, splicing seams between the display panels may become invisible. To make the above-mentioned features and advantages of the disclosure more

apparent and understandable, exemplary embodiments are described below with reference to the accompanying drawings in detail as follows.

### BRIEF DESCRIPTION OF THE DRAWINGS

FIG. 1A is a schematic diagram of a display device according to an embodiment of the disclosure, and FIG. 1B is a schematic diagram of a display panel according to an embodiment of the disclosure.

FIG. 2A, FIG. 2B, and FIG. 2C are schematic cross-sectional diagrams of a display panel according to an embodiment of the disclosure.

FIG. 3 is a partial cross-sectional diagram of a side display region of a display panel according to an embodiment of the disclosure.

FIG. 4 is a partial cross-sectional diagram of a side display region of a display panel according to an embodiment of the disclosure.

### DESCRIPTION OF THE EMBODIMENTS

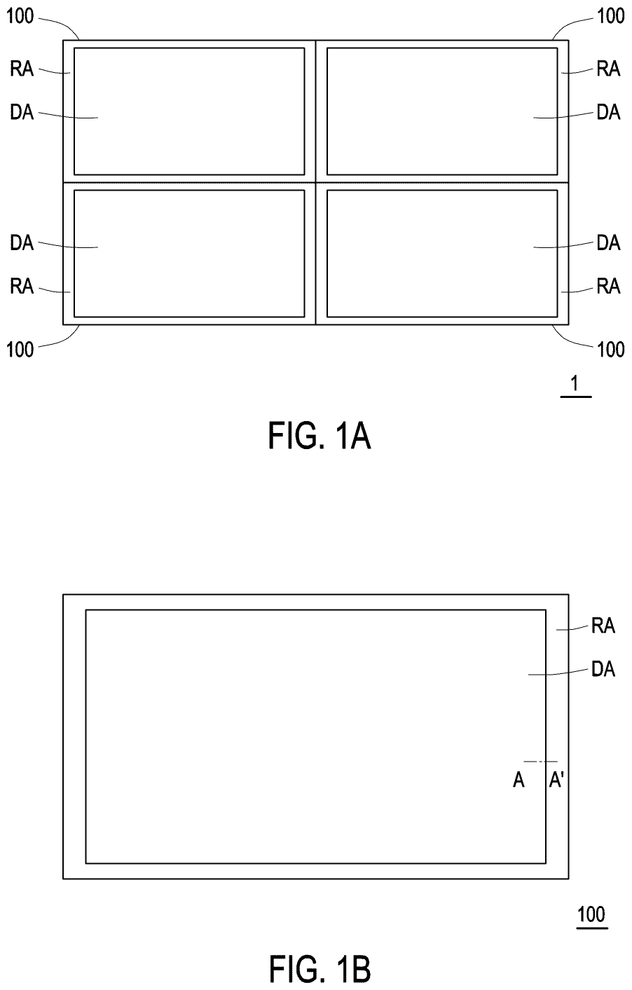

With reference to FIG. 1A and FIG. 1B, FIG. 1A is a schematic diagram of a display device according to an embodiment of the disclosure, and FIG. 1B is a schematic diagram of a display panel according to an embodiment of the disclosure. A display device 1 includes a plurality of display panels 100 disposed in an array, and each of the display panels 100 includes a liquid crystal display region DA and a side display region RA. Each pair of the adjacent display panels 100 adjoin each other by their respective side display regions RA.

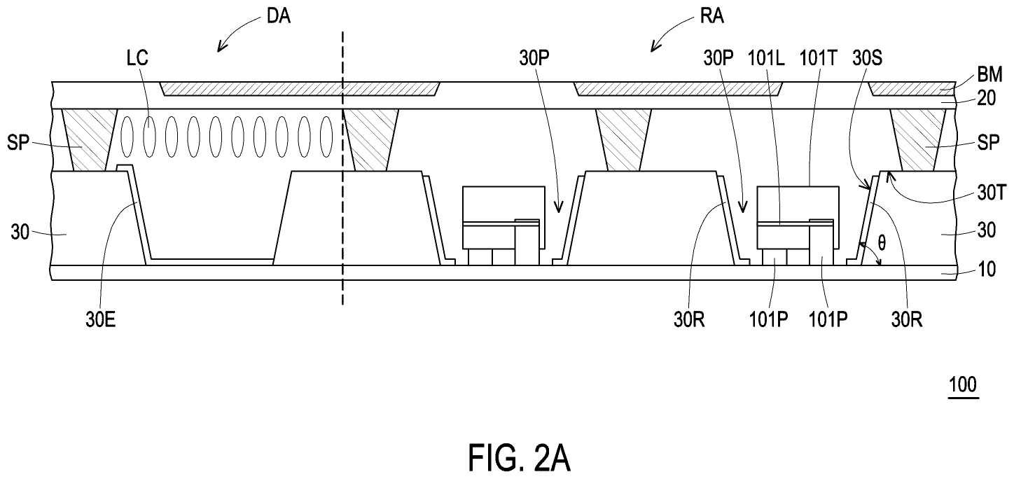

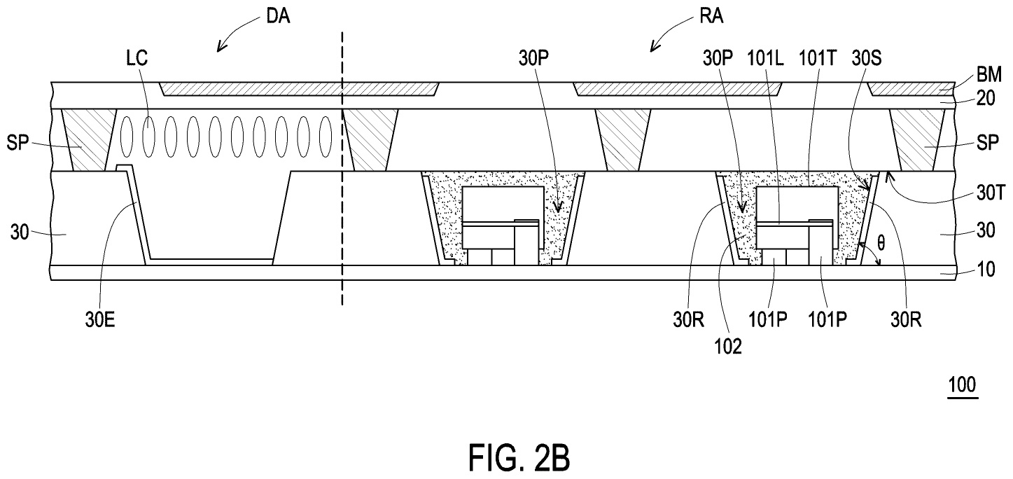

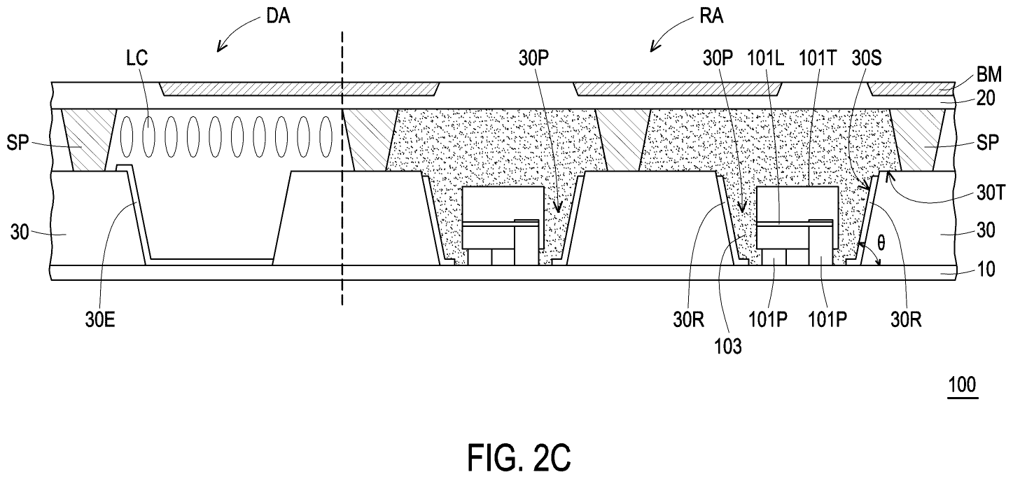

With reference to FIG. 1A, FIG. 1B and FIG. 2A, FIG. 2A is a schematic cross-sectional diagram of the display panel 100 along a line segment AA' according to an embodiment of the disclosure.

In this embodiment, the display panel 100 includes a lower substrate 10, an upper substrate 20, a planarization layer 30, and a plurality of light emitting diodes (LEDs) 101. The lower substrate 10 may be, for instance, a substrate having circuits or a TFT substrate. Each of the LEDs 101 includes a pad 101P which may be made of metal or alloy, such as copper, indium, indium-bismuth alloy, tin-bismuth alloy, lead-tin alloy, zinc-tin alloy, and so on. The planarization layer 30 is disposed on the lower substrate 10, extends from the liquid crystal display region DA to the side display region RA of the display panel 100, and defines a plurality of notches 30P in the side display region RA. In other words, the multiple notches 30P are defined by the contour of the planarization layer 30. Heights of light emitting layers 101L of the LEDs 101 relative to the lower substrate 10 are less than a height of a top surface 30T of the planarization layer 30 relative to the lower substrate 10.

Specifically, in this embodiment, the display panel 100 has liquid crystal molecules LC and a corresponding transparent electrode layer 30E disposed in the liquid crystal display region DA to achieve image display in the liquid crystal display region DA. The LEDs 101 are respectively disposed in the notches 30P in the side display region RA and are electrically connected to the lower substrate 10 through the pads 101P of the LEDs 101 to achieve image display in the side display region RA.

It should be noted that in a comparative example not shown in the drawings, the display panel has liquid crystal molecules LC and a corresponding transparent electrode layer 30E disposed in the liquid crystal display region DA to achieve image display in the liquid crystal display region DA. However, the display pane provided in the comparative example is not equipped with the side display region RA. Moreover, a peripheral region surrounding the liquid crystal display region DA cannot perform the display function. Therefore, when splicing the liquid crystal display panels provided in this comparative example to form a spliced display device, the peripheral region of each display panel contains visible splicing seams between the display panels, reducing the display quality of the resultant spliced display device.

In contrast, each display panel 100 provided in this embodiment may display images in its liquid crystal display region DA and may also display images in its side display region RA through the LEDs 101. Therefore, when the display device 1 is formed by splicing the display panels 100 provided in this embodiment, the splicing seams between the display panels 100 become invisible, significantly enhancing the display quality of the display device 1.

Note that the side display region RA of the display panel 100 is not limited to being arranged on all the four sides of the display panel 100 and around the liquid crystal display region DA as shown in FIG. 1A and FIG. 1B. According to the embodiment of the disclosure, the side display region RA of the display panel 100 may be disposed on at least one side of the display panel 100.

Similarly, with reference to FIG. 2A, the display panel 100 may further include reflective layers 30R in the side display region RA. The reflective layers 30R are disposed on the planarization layer 30 and defines inner surfaces 30S of the notches 30P. In other words, the inner surfaces 30S of the notches 30P are constituted by the reflective layers 30R. The reflective layers 30R serve to reflect light emitted from the light emitting layers 101L of the LEDs 101, and a reflectance of the reflective layers 30R is greater than 50%. Specifically, the reflective layers 30R may include metal layers, such as aluminum, which should however not be construed as a limitation in the disclosure. The reflective layers 30R may also include layers with diffusive properties, such as gold (Au) spheres and TiO₂.

The inner surfaces 30S are inclined relative to the lower substrate 10, and an inclination angle θ exists between the inner surfaces 30S and the lower substrate 10. In some embodiments, the inclination angle θ may fall within a range from 15 degrees to 35 degrees. Since heights of the top surfaces 101T of the LEDs 101 relative to the lower substrate 10 are less than the height of the top surface 30T of the planarization layer 30 relative to the lower substrate 10, and the heights of the light emitting layers 101L of the LEDs 101 relative to the lower substrate 10 are less than the height of the top surface 30T of the planarization layer 30 relative to the lower substrate 10, light emitted from the light emitting layers 101L of the LEDs 101 is reflected by the reflective layers 30R. The notches 30P defined by the planarization layer 30 and the inclined inner surfaces 30S defined by the reflective layers 30R provide a light concentrating function, thus enabling light emitting patterns in the side display region RA to be similar to light emitting patterns in the liquid crystal display region DA. Accordingly, a consistent visual experience may be provided in both the side display region RA and the liquid crystal display region DA. In some embodiments, a distance between the top surfaces 101T of the LEDs 101 and the top surface 30T of the planarization layer 30 in a normal direction of the lower substrate 10 is greater than 1 micrometer, allowing light emitted from the light emitting layers 101L of the LEDs 101 to be sufficiently reflected by the reflective layers 30R.

In order to fully explain various implementation aspects provided in the disclosure, other embodiments of the disclosure are described below. Note that the reference numbers and part of the content provided in following embodiments are derived from those provided in the previous embodiments, where the same reference numbers serve to represent the same or similar elements, and explanations of identical technical content are omitted. The explanations of the omitted parts may be found in the previous embodiments and will not be repeatedly provided in the following embodiment.

With reference to FIG. 1A, FIG. 1B, and FIG. 2B, FIG. 2B is a schematic cross-sectional diagram along the line segment AA′ of the display panel 100 according to another embodiment of the disclosure.

Compared to the embodiment shown in FIG. 2A, the display panel 100 provided in this embodiment further includes a filler medium layer 102 to adjust the light emitting patterns in the side display region RA. The filler medium layer 102 is disposed within the notches 30P and encapsulates the LEDs 101.

With reference to FIG. 1A, FIG. 1B and FIG. 2C, FIG. 2C is a schematic cross-sectional diagram along the line segment AA′ of the display panel 100 according to yet another embodiment of the disclosure.

Compared to the embodiment shown in FIG. 2A, the display panel 100 provided in this embodiment further includes a filler medium layer 103 to adjust the light emitting patterns in the side display region RA. The filler medium layer 103 is disposed within the notches 30P and between the planarization layer 30 and the upper substrate 20 and encapsulates the LEDs 101.

In some embodiments, hazes of the filler medium layer 102 and the filler medium layer 103 may be less than 10%, so that the display panel 100 may have sufficient brightness and good image uniformity. The filler medium layer 102 and the filler medium layer 103 may include a colloid layer and scattering particles dispersed within the colloid layer. The colloid layer may, for instance, include epoxy resin and acrylic resin, while the scattering particles may, for instance, include AU spheres and silicon oxide and may also include fillers or curing agents. A volume percentage concentration of the scattering particles may be less than 20%. The colloid layer may further serve as a sealant for the display panel 100. A difference in a refractive index between the colloid layer and the scattering particles may be less than 0.2 to avoid excessive scattering. However, the filler medium layer 102 and the filler medium layer 103 are not limited to include the aforesaid scattering materials. In some embodiments, the filler medium layer 102 and the filler medium layer 103 may not have the scattering ability, and their refractive indices may fall within the range from 1.4 to 1.8.

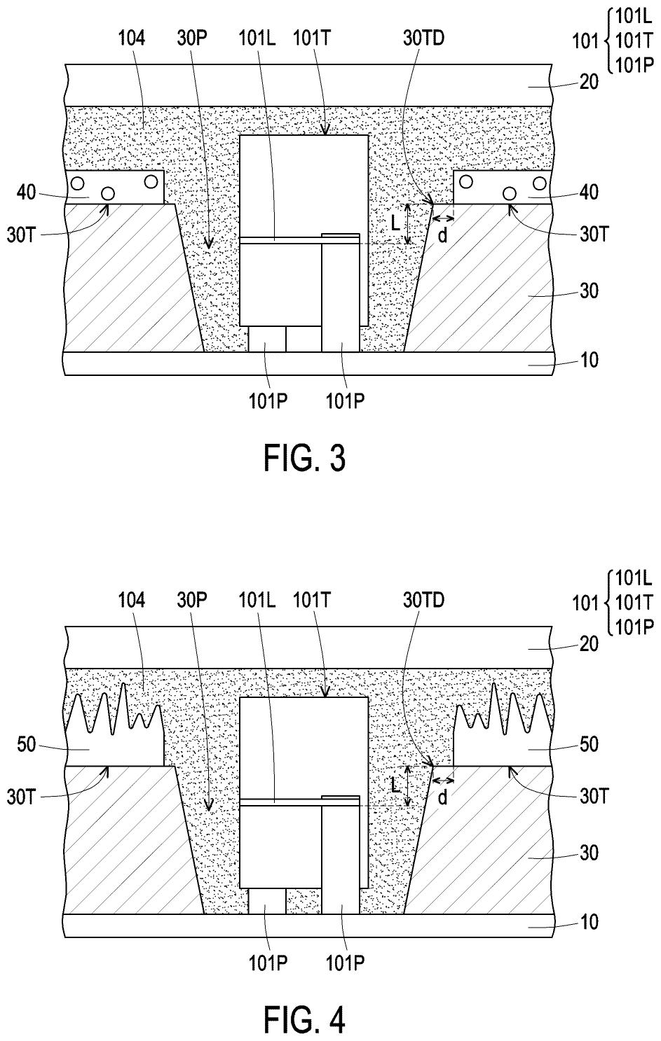

With reference to FIG. 3, FIG. 3 is a partial cross-sectional diagram of a side display region of a display panel according to an embodiment of the disclosure. Specifically, FIG. 3 illustrates an alternative example of the side display region RA in FIG. 2A to FIG. 2C. In this embodiment, the heights of the top surfaces 101T of the LEDs 101 relative to the lower substrate 10 are greater than the height of the top surface 30T of the planarization layer 30 relative to the lower substrate 10. A filler medium layer 104 is disposed within the notches 30P and between the planarization layer 30 and the upper substrate 20, and a diffusive-reflective layer 40 is disposed on the top surface 30T of the planarization layer 30. A refractive index of the filler medium layer 104 is greater than 1.6. It should be noted that a reflectance of the diffusive-reflective layer 40 in a specular component exclude (SCE) mode is greater than 40%, which enables the light reflected by the upper substrate 20 and traveling towards the planarization layer 30 to be sufficiently diffused and reflected by the diffusive-reflective layer 40, enhancing the forward light emission performance of the display panel 100. In some embodiments, the minimum distance d between the diffusive-reflective layer 40 and the top side 30TD of the planarization layer 30 and the distance L between the top side 30TD of the planarization layer 30 and the light emitting layers 101L in the normal direction of the lower substrate 10 satisfy the condition 1.2 L>d>0.8 L. Accordingly, the diffusive-reflective effect may be optimized, the forward light emission performance of the display panel 100 may be enhanced, and the light emitting patterns in the side display region RA may be similar to the light emitting patterns in the liquid crystal display region DA.

The diffusive-reflective layer 40 may, for instance, include polymethyl methacrylate (PMMA) or epoxy and TiO₂ having a volume percentage concentration greater than 20%. A thickness of the diffusive-reflective layer 40 may fall within a range from 1 micrometer to 3 micrometers. In some embodiments, a reflectance of the diffusive-reflective layer 40 may be greater than 45%, and a haze of the diffusive-reflective layer 40 may be greater than 45%. In some embodiments, the distance L between the top side 30TD of the planarization layer 30 and the light emitting layers 101L in the normal direction of the lower substrate 10 falls within the range from 0.5 micrometer to 1 micrometer, which should however not be construed as a limitation in the disclosure. It should also be explained that the top side 30TD of the planarization layer refers to the intersection between the top surface 30T of the planarization layer 30 and the notches 30P, i.e., where the planarization layer 30 begins to recess.

In some other embodiments, the reflective layers 30R are further disposed on the planarization layer 30 shown in FIG. 3 to define the inner surfaces 30S of the notches 30P, as shown in the embodiments depicted in FIG. 2A to FIG. 2C mentioned above, which will not be repeated hereinafter.

With reference to FIG. 4, FIG. 4 is a partial cross-sectional diagram of a side display region of a display panel according to an embodiment of the disclosure. Specifically, FIG. 4 illustrates an alternative example of the side display region RA in FIG. 2A to FIG. 2C. In this embodiment, the heights of the top surfaces 101T of the LEDs 101 relative to the lower substrate 10 is greater than the height of the top surface 30T of the planarization layer 30 relative to the lower substrate 10. A filler medium layer 104 is disposed within the notches 30P and between the planarization layer 30 and the upper substrate 20, and a diffusive-reflective layer 50 is disposed on the top surface 30T of the planarization layer 30. A refractive index of the filler medium layer 104 is greater than 1.6, and an absolute value of a difference in the refractive index between the filler medium layer 104 and the diffusive-reflective layer 50 is greater than 0.15. It should be noted that a reflectance of the diffusive-reflective layer 50 in the SCE mode is greater than 40%, which enables the light reflected by the upper substrate 20 and traveling towards the planarization layer 30 to be sufficiently diffused and reflected by the diffusive-reflective layer 50, enhancing the forward light emission performance of the display panel 100. In some embodiments, the minimum distance d between the diffusive-reflective layer 50 and the top side 30TD of the planarization layer 30 and the distance L between the top side 30TD of the planarization layer 30 and the light emitting layers 101L in the normal direction of the lower substrate 10 satisfy the condition 1.2 L>d>0.8 L. Accordingly, the aforementioned diffusive-reflective effect may be optimized, the forward light emission performance of the display panel 100 may be enhanced, and the light emitting patterns in the side display region RA may be similar to the light emitting patterns in the liquid crystal display region DA.

The diffusive-reflective layer 50 has a rough surface, a thickness of a base of the diffusive-reflective layer 50 may fall within a range from 1 micrometer to 3 micrometers, and the rough particles on the base may have a height greater than 0.5 micrometer. In some embodiments, the reflectance of the diffusive-reflective layer 50 may be greater than 45%. In some embodiments, the distance L between the top side 30TD of the planarization layer 30 and the light emitting layers 101L in the normal direction of the lower substrate 10 falls within the range from 0.5 micrometer to 1 micrometer, which should however not be construed as a limitation in the disclosure. It should also be explained that the aforesaid top side 30TD of the planarization layer refers to the intersection of the top surface 30T of the planarization layer 30 and the notches 30P, i.e., where the planarization layer 30 begins to recess.

In some other embodiments, the reflective layers 30R are further disposed on the planarization layer 30 shown in FIG. 4 to define the inner surfaces 30S of the notches 30P, as shown in the embodiments depicted in FIG. 2A to FIG. 2C mentioned above, which will not be repeated hereinafter.

To sum up, the display panel provided in one or more embodiments of this disclosure may display images in its liquid crystal display region and may also display images in its side display region through the LEDs. Therefore, when plural display panels are spliced to form a spliced display device, the splicing seams between the display panels may become invisible. In addition, the notches defined by the planarization layer and the inclined inner surfaces defined by the reflective layers provide a light concentrating function, thus enabling the light emitting patterns in the side display region to be similar to the light emitting patterns in the liquid crystal display region. Moreover, the diffusive-reflective layer disposed on the planarization layer may enable light reflected by the upper substrate and traveling towards the planarization layer to be sufficiently diffused and reflected, further enhancing the forward light emission performance of the display panel.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, having a liquid crystal display region and a side display region and comprising:
a lower substrate;
a planarization layer, disposed on the lower substrate, extending from the liquid crystal display region to the side display region, and defining a plurality of notches in the side display region; and
a plurality of light emitting diodes, respectively disposed in the notches in the side display region, wherein a reflectance of an inner surface of each of the notches is greater than 50%.

2. The display panel according to claim 1, wherein the inner surface is inclined relative to the lower substrate, an inclination angle exists between the inner surface and the lower substrate, and the inclination angle is 15 degrees to 35 degrees.

3. The display panel according to claim 1, wherein heights of light emitting layers of the light emitting diodes relative to the lower substrate are less than a height of a top surface of the planarization layer.

4. The display panel according to claim 3, further comprising a filler medium layer disposed in the notches and encapsulating the light emitting diodes, wherein a haze of the filler medium layer is less than 10%.

5. The display panel according to claim 4, further comprising an upper substrate, the filler medium layer being further disposed between the planarization layer and the upper substrate.

6. The display panel according to claim 3, wherein a distance between top surfaces of the light emitting diodes and the top surface of the planarization layer in a normal direction of the lower substrate is greater than 1 micrometer.

7. The display panel according to claim 1, further comprising a metal layer disposed on the planarization layer and defining the inner surfaces of the notches.

8. The display panel according to claim 1, further comprising a diffusive-reflective layer disposed on the planarization layer, wherein a minimum distance (d) between the diffusive-reflective layer and a top side of the planarization layer, and a distance (L) between the top side of the planarization layer and the light emitting layers of the light emitting diodes in the normal direction of the lower substrate satisfy a condition 1.2 L>d>0.8 L.

9. The display panel according to claim 8, wherein a height of the top surface of the planarization layer relative to the lower substrate is greater than heights of the light emitting layers of the light emitting diodes and less than heights of top surfaces of the light emitting diodes.

10. The display panel according to claim 8, wherein a reflectance of the diffusive-reflective layer is greater than 45%.

11. The display panel according to claim 8, wherein a haze of the diffusive-reflective layer is greater than 45%.

12. The display panel according to claim 8, wherein a reflectance of the diffusive-reflective layer in a specular component exclude mode is greater than 40%.

13. The display panel according to claim 8, wherein the diffusive-reflective layer comprises TiO₂ with a volume percentage concentration greater than 20%.

14. A display device, comprising a plurality of the display panels according to claim 1, the display panels being disposed in an array, wherein at least two of the side display regions are adjacent to each other.
